(19) United States
(12) Patent Application Publication
(10) Pub. No.: US 2025/0383319 A1
(43) Pub. Date: Dec. 18, 2025

(54) ION MOBILITY SEPARATORS

(71) Applicant: Micromass UK Limited, Wilmslow (GB)

(72) Inventors: Jason L. Wildgoose, Stockport (GB); Martin Raymond Green, Bowdon (GB)

(73) Assignee: Micromass UK Limited, Wilmslow (GB)

(21) Appl. No.: 18/867,543

(22) PCT Filed: May 19, 2023
(86) PCT No.: PCT/GB2023/051327

§ 371 Date: Nov. 20, 2024

(30) Foreign Application Priority Data
May 20, 2022 (GB) 2207395.1

(51) Int. Cl. G01N 27/622; H01J 49/00

(52) U.S. Cl. CPC G01N 27/622; H01J 49/009

(57) ABSTRACT

An ion mobility separation apparatus comprising: a plurality of ion mobility separator (IMS) devices (12.13) arranged in parallel: an entrance gate (25) configured to direct ions into one or more of said IMS devices at any given time; and control circuitry configured to operate each of the IMS devices in a separation mode in which first voltages are applied to electrodes of the IMS device so as to provide a static DC electric field that urges ions along the IMS device in one direction, and to also apply second voltages to electrodes of the IMS device so as to provide a DC potential that repeatedly travels along the IMS device in the opposite direction such that ions separate according to their mobility within the IMS device.

### CROSS-REFERENCE TO RELATED APPLICATION

This application claims priority from and the benefit of United Kingdom patent application No. 2207395.1 filed on 20 May 2022. The entire content of this application is incorporated herein by reference.

### FIELD OF THE INVENTION

The present invention relates generally to mass spectrometers and in particular to techniques for separating ions according to a physicochemical property such as ion mobility, or mass to charge ratio.

### BACKGROUND

An ion mobility separator (IMS) is a known device for separating ions according to their mobility through a gas. An example of such an IMS device is a drift tube IMS device. These devices have an ion trap that pulses a packet of ions into a drift tube that has a background gas therein. A static DC gradient is maintained along the drift tube so as to urge the ions through the gas from the upstream end, near the ion trap, to a downstream end. Ions of different mobility will have different transit times through the gas to the exit of the drift tube and hence are separated according to their mobility.

Travelling wave IMS devices are also known. In these devices a DC potential is repeatedly travelled along the drift tube so as to urge the ions in the downstream direction towards the exit of the drift tube, rather than providing a static DC gradient along the drift tube for urging the ions. Ions having different mobilities are urged downstream by different amounts each time that they are passed by a travelling DC potential. As such, the travelling DC potentials cause the ions to become separated and exit the IMS device at different times based on their mobility.

However, as such conventional IMS devices trap all of the ions prior to pulsing them into the drift tube to be separated, these devices suffer from space-charge effects because the ions are trapped with a relatively high concentration of charge in the ion trap. Such space-charge effects reduce the mobility resolution of IMS devices and may also cause ion losses.

Other types of IMS devices are known that separate ions according to ion mobility within an ion trap and then release the ions from the ion trap in order of mobility. These devices trap the ions and then provide opposing forces on the ions such that they separate out along the trapping region according to their mobility. For example, a gas flow may urge the ions in a first direction and a static DC gradient may urge the ions in a second, opposite direction so as to cause the ions to separate according to mobility within the ion trapping region. The gradient of the static DC gradient may then be progressively reduced such that ions elute from the trapping region in order of ion mobility, i.e. ions of relatively low mobility elute first, followed by progressively higher mobility ions as the DC gradient is progressively reduced.

### SUMMARY

A first aspect of the present invention provides an ion mobility separation apparatus comprising: a plurality of ion mobility separator (IMS) devices arranged in parallel; an entrance gate configured to direct ions into one or more of said IMS devices at any given time; and control circuitry configured to operate each of the IMS devices in a separation mode in which first voltages are applied to electrodes of the IMS device so as to provide a static DC electric field that urges ions along the IMS device in one direction, and to also apply second voltages to electrodes of the IMS device so as to provide a DC potential that repeatedly travels along the IMS device in the opposite direction such that ions separate according to their mobility within the IMS device.

The inventors have recognised that by providing multiple IMS devices in parallel, where the IMS devices use voltages to apply electrostatic forces on the ions in both of the directions (e.g. instead of using a gas flow to urge ions), a relatively high space-charge capacity ion separation apparatus is provided that can be operated with relatively low vacuum pump requirements.

Many conventional IMS devices force ions into a relatively small volume prior to pulsing the ions into a drift region in which the ions separate according to mobility, because it is desired to pulse all of the ions into the drift region at substantially the same time in order for the IMS device to provide high mobility resolution. As such, these devices can suffer from space-charge effects even with relatively small ion populations, and even if multiple such IMS devices were to be provided in parallel.

In contrast, embodiments of the present invention do not pulse the ions through a drift region so as to cause them to separate by mobility. Rather, the ions are separated by opposing forces in a trapping region. As such, the ions need not be confined or focused in a small volume and hence space-charge effects are not as prevalent. Also, the present invention enables ions to be directed into multiple IMS devices and so a relatively high number of ions can be processed by the apparatus before space-charge effects within any given one of the IMS devices become problematic.

The static DC electric field of the present invention may have a gradient such that the magnitude of the electric field increases as a function of increasing distance in said opposite direction, e.g. the amplitude of the DC potential may increase quadratically as a function of increasing distance in the opposite direction.

Each time the DC potential is travelled along the IMS device, it may decrease in amplitude (and/or increase in speed).

Each time a DC potential described herein is travelled along the device, ions having different mobilities are urged along by it by different amounts. As such, the travelling DC potentials cause the ions to become separated based on their mobility.

The apparatus may be configured to operate each of the IMS devices in an elution mode, after operating in the separation mode, during which: (i) the first voltages are progressively varied so that a gradient of the static DC electric field progressively varies in a manner that causes ions to elute from the IMS device in order of mobility, or reverse order of mobility, as time progresses; and/or (ii) the second voltages are progressively varied such that at least one property of the DC potential that is repeatedly travelled along the IMS device is progressively varied so as to cause ions to elute from the IMS device in order of mobility, or reverse order of mobility, as time progresses.

For example, the amplitude of the DC potential may be progressively reduced or increased, as a function of time, so as to cause ions to elute from the IMS device in order of mobility, or reverse order of mobility, as time progresses. Alternatively, or additionally, the speed of the DC potential may be progressively increased or decreased, as a function of time.

Each of the IMS devices is arranged to receive ions from the entrance gate at its upstream end, to operate in the separation mode so as to separate ions according to mobility, and to then operate in the elution mode so as to cause ions of different mobility to elute from the IMS device at different respective times. The ions preferably elute from a downstream end of the IMS device that is at the opposite end of the IMS device to the upstream end.

The separation mode separates ions in a trapping region. A region of substantially constant DC electric field may be provided immediately downstream of the trapping region, which further separates the ions according to mobility once they elute from the trapping region.

The separated ions are caused to elute from the IMS device, e.g. such that ions of progressively higher mobility exit the IMS device as time progresses or such that ions of progressively lower mobility exit the IMS device as time progresses.

The IMS devices are arranged in parallel, rather than in series, i.e. such that each IMS device can receive ions from the entrance gate without those ions having been transmitted through a different IMS device.

The apparatus may comprise control circuitry configured to control the elution of ions from the plurality of IMS devices such that at any given time the ions exiting all of the IMS devices have substantially the same mobility.

The apparatus may comprise control circuitry configured to control the ion mobility separation apparatus such that, during a first time period, the entrance gate causes ions to be supplied into a first of the IMS devices so as to accumulate and separate ions in the first IMS device and such that, whilst the ions are being accumulated and separated, a second of the IMS devices is caused to elute ions in order of ion mobility or in reverse order of ion mobility. Optionally, the control circuitry is configured to control the ion mobility separation apparatus such that, during a second subsequent time period, the entrance gate causes ions to be supplied into the second of the IMS devices so as to accumulate and separate ions in the second IMS device and such that, whilst the ions are being accumulated and separated in the second IMS device, the first IMS device is caused to elute ions in order of mobility or in reverse order of ion mobility.

Each IMS device may comprise an ion guide, such as an elongated ion guide, having electrodes and RF voltages applied thereto such that ions are radially confined within the ion guide. The ion guide may be an ion tunnel ion guide, e.g. formed from apertured electrodes such as ring electrodes, or any other type of ion guide, such as a multipole rod set ion guide.

The apparatus may further comprise an upstream ion guide for guiding an ion beam to the entrance gate, wherein the entrance gate is configured to either: (i) split the ion beam into a plurality of ion beams that are simultaneously directed into a respective plurality of the IMS devices; or (ii) direct the ion beam into different ones of the IMS devices at different times.

The entrance gate may be arranged to receive ions along a first axis and comprises opposing arrays of electrodes that are spaced apart from each other and at least one voltage source for applying at least one RF voltage to the electrodes of said arrays for confining ions in an ion guiding region between the arrays.

Each array of electrodes may comprise a plurality of rows of electrodes and/or a plurality of columns of electrodes. The columns of electrodes may be substantially parallel to the first axis and the rows of electrodes may be substantially perpendicular to the first axis.

The same phase RF potential may be applied to all of the electrodes in the same column of electrodes, whereas any given adjacent pair of columns of electrodes may be maintained at different RF phases, preferably opposite RF phases. However, it is alternatively contemplated that same phase RF potential may be applied to all of the electrodes in the same row, and any given pair of adjacent rows of electrodes may be maintained at different RF phases, preferably opposite RF phases. If the arrays have both rows and columns of electrodes then adjacent electrodes in each row may be at opposite RF phases and adjacent electrodes in each column may be at opposite RF phases.

The entrance gate may comprise a side electrode on each side of the first axis and at least one voltage supply for applying voltages to the side electrodes so as to urge the ions orthogonal to the first axis.

Each of the IMS devices may have a longitudinal axis therethrough along which ions are received; wherein at least one, or each of at least some, of the IMS devices has its longitudinal axis displaced from the first axis; and wherein the entrance gate has control circuitry configured to apply different DC voltages to different electrodes in the arrays, and/or to different side electrodes, so as to deflect ions received along said first axis onto one or more longitudinal axis of one or more of the IMS devices so that the ions enter said one or more of the IMS devices.

The ion mobility separation assembly may comprise a mobility filter for filtering ions according to their mobility so that only ions in a selected range of mobilities are transmitted into one or more of the IMS devices and other ions are filtered out. This helps further avoid space-charge effects in the IMS devices, e.g. by filtering out relatively abundant low mobility ions that are of low interest.

The different DC voltages may provide a static DC electric field that urges the ions in a first direction that is orthogonal to the first axis, and the control circuitry may be configured to also apply voltages to electrodes of the entrance gate so as to provide a DC potential that repeatedly travels in a second direction along the entrance gate that is opposite to the first direction such that ions separate according to their mobility along the first direction and hence have different trajectories through the entrance gate.

The ions therefore exit the entrance gate at different positions depending on their mobilities.

The control circuitry may control the values of the different DC voltages and the parameters of the DC travelling potentials such that ions having a selected range of mobilities exit the entrance gate at a location so as to be able to enter the one of more of the IMS devices.

Different DC potentials may be applied to different electrodes in the arrays so as to urge ions along the first axis from an entrance of the entrance gate to its exit.

However, it is contemplated that the entrance gate may take other forms. For example, the entrance gate may comprise a first, transition portion having electrodes located to receive ions along a first axial path, a second portion having electrodes configured to guide ions along an axial path to a first of the IMS devices, and a third portion having electrodes configured to guide ions along an axial path to a second of the IMS devices, wherein the electrodes that receive ions along the first axial path are arranged to provide at least one gap at a circumferential location around the first axial path, and wherein the entrance gate comprises a voltage supply for applying DC voltages to the electrodes of the entrance gate so that ions are urged orthogonally from the first axial path, through the at least one gap, and onto the axial path to the first and/or second IMS device.

The first axial path, the axial path to the first IMS device and the axial path to the second IMS device may all be displaced from each other. Alternatively, the first axial path may be displaced from the axial path to the first IMS device but may coincide with the axial path to the second IMS device. In other words, ions may be urged orthogonally from the first axial path to the axial path leading to the first IMS device, but may not be urged orthogonally when they are to continue to the second IMS device.

The entrance gate may comprise at least one stack of plate electrodes arranged between a first electrode and a second electrode so as to define a first ion guiding path for guiding ions from an ion entrance region of the entrance gate to a first of the IMS devices, and a second ion guiding path for guiding ions from the ion entrance region to a second of the IMS devices.

Where multiple stacks of electrodes are provided, the different stacks may be spaced apart (in a direction orthogonal to the direction between the first and second electrodes) so as to define the ion guiding paths between the stacks.

The electrodes in the at least one stack, and optionally the top and bottom electrodes, may be maintained at RF voltages such that ions are repelled from them. Adjacent electrodes, in the direction between the top and bottom electrodes, may be maintained at different phases of the RF voltage, such as opposite phases. Electrodes in different stacks, but within the same layer, may be maintained at the same RF phase. A DC voltage may be applied to the top and bottom electrodes in addition to, or alternatively to, applying the RF voltages in order to repel ions.

The apparatus may further comprise a downstream ion guide and an exit gate between the IMS devices and the downstream ion guide, wherein the exit gate is configured to receive ions from the plurality of IMS devices and guide the ions into the downstream ion guide.

Ions may elute from the plurality of IMS devices simultaneously and these multiple ion streams from the plurality of IMS devices may be combined by the exit gate so as to form a single ion beam.

Although the preferred embodiments employ DC voltages within each IMS device in order to urge the ions in opposite directions and cause them to separate by mobility, it is contemplated that the ions may be urged in one or both of the directions by another force, e.g. such as a gas flow.

Accordingly, a second aspect of the present invention provides an ion mobility separation apparatus comprising: a plurality of ion mobility separator (IMS) devices arranged in parallel; an entrance gate configured to direct ions into one or more of said IMS devices at any given time; and control circuitry configured to operate each of the IMS devices in a separation mode in which voltages are applied to electrodes of the IMS device so as to urge ions along the IMS device in one direction, and wherein the apparatus is configured to provide a gas flow in the opposite direction such that ions separate according to their mobility within the IMS device.

The gas flow may be provided in the downstream direction (i.e. in the direction away from the ion source), although less preferably the gas flow may be provided in the upstream direction.

The control circuitry may be configured to apply said voltages to the electrodes of the IMS device so as to provide a static DC electric field that urges ions in said one direction. For example, the electric field may have a gradient such that the magnitude of the electric field increases as a function of increasing distance in said opposite direction, e.g. the amplitude of the DC potential may increase quadratically as a function of increasing distance in said opposite direction.

Alternatively, the control circuitry may be configured to apply said voltages to the electrodes of the IMS device so as to provide a DC potential that is repeatedly travelled along the IMS device in said one direction. The DC potential may reduce in amplitude each time it travels in said one direction.

The apparatus according to the second aspect of the invention may have any of the features described in relation to the first aspect of the invention, except that the gas flow is used to urge the ions in one of the directions.

For example, the apparatus may have the entrance gate described herein, which may filter ions by mobility.

It is contemplated that ions may be separated by a physicochemical property other than or in addition to mobility, such as mass to charge ratio. For instance, it is known that in IMS devices in which a DC potential is repeatedly travelled along the device in order to separate ions by mobility, there is a mass to charge ratio dependence in the ion separation, e.g. as described in K. Richardson, D. Langridge, K. Giles, Fundamentals of travelling wave ion mobility revisited: I. Smoothly moving waves, International Journal of Mass Spectrometry, Volume 428, 2018, Pages 71-80. Operational parameters of the separator, such as pressure and/or speed of the travelling DC potentials, may be selected such that it primarily separates ions by mobility, such that it primarily separates ions by mass to charge ratio, or such that it operates in a mode where the ion separation is significantly dependent on both mobility and mass to charge ratio. It is also contemplated that the separator can be switched between two or more of these modes by varying one or more of its operational parameters. For example, embodiments are contemplated in which the pressure within the separator is reduced so as to reduce the mobility dependence of the separation and increase the mass to charge ratio dependence of the separation. Such an embodiment may switch from a mode that primarily separates ions by mobility to a mode that primarily separates ions by mass to charge ratio by reducing the pressure in the separator.

In the mode where the ions are separated primarily according to mobility, the separated ions may be allowed to elute from the separator in order of increasing or decreasing mobility. The calibration of the elution times of ions to their mobility values may take into account the mass to charge ratio dependence of the ion separation. Similarly, in the mode where the ions are separated primarily according to mass to charge ratio, the separated ions may be allowed to elute from the separator in order of increasing or decreasing mass to charge ratio. The calibration of the elution times of ions to their mass to charge ratio values may take into account the mobility dependence of the ion separation.

Accordingly, from a third aspect the present invention also provides an ion separation apparatus comprising: a plurality of separator devices arranged in parallel, each for separating ions according to a physicochemical property; an entrance gate configured to direct ions into one or more of said separator devices at any given time; and control circuitry configured to operate each of the separator devices in a separation mode in which first voltages are applied to electrodes of the separator device so as to provide a static DC electric field that urges ions along the separator device in one direction, and to also apply second voltages to electrodes of the separator device so as to provide a DC potential that repeatedly travels along the separator device in the opposite direction such that ions separate according to a physicochemical property within the separator device.

The apparatus according to the third aspect of the invention may have any of the features described in relation to the first aspect of the invention, except that the ions are separated according to a physicochemical property other than mobility.

For example, the apparatus may have the entrance gate described above.

The physicochemical property may be, for example, mass to charge ratio.

The present invention also provides a mass spectrometer and/or ion mobility spectrometer comprising the apparatus for separating ions by mobility or said physicochemical property, as described herein. The spectrometer may comprise a mass analyser and detector for mass analysing and/or detecting the ions, or ions derived therefrom.

The present invention also provides a method of separating ions by ion mobility comprising: providing an ion mobility separation apparatus according to any preceding claim; providing ions to the entrance gate and controlling the entrance gate so as to direct ions into one or more of said IMS devices at any given time; and operating the IMS devices so as to operate, simultaneously or sequentially, in the separation mode so as to separate ions according to their mobility.

The present invention also provides a method of separating ions according to a physicochemical property, comprising: providing an ion separation apparatus as described herein above; providing ions to the entrance gate and controlling the entrance gate so as to direct ions into one or more of said separation devices at any given time; and operating the separation devices so as to operate, simultaneously or sequentially, in the separation mode so as to separate ions according to the physicochemical property.

The present invention also provides a method of mass spectrometry and/or ion mobility spectrometry comprising separating the ions by mobility or said physicochemical property, as described herein, and then mass analysing and/or detecting the ions or ions derived therefrom.

### BRIEF DESCRIPTION OF THE DRAWINGS

Various embodiments of the present invention will now be described, by way of example only, and with reference to the accompanying drawings in which:

FIG. 1 shows a schematic of a known IMS device;

FIG. 2 shows an embodiment of the present invention;

FIGS. 3A-3C shows embodiments of an ion separator that uses a travelling DC potential to separate ions;

FIG. 4 shows another embodiment that is similar to FIG. 2;

FIG. 5 shows an embodiment illustrating an entrance gate for deflecting ions into different IMS devices;

FIGS. 6A-6B show an embodiment of an entrance gate comprising arrays of electrode;

FIGS. 7A-7B show an embodiment of an exit gate comprising arrays of electrode;

FIG. 8 shows another embodiment of the entrance gate that corresponds to that shown in FIG. 6A, except having multiple side electrodes on each side;

FIGS. 9A-9C show an embodiment of the entrance gate when operating as an ion mobility filter;

FIGS. 10A-10B show another embodiment of the entrance gate; and

FIGS. 11A-11B show another embodiment of the entrance gate formed from stacked plate electrodes.

### DETAILED DESCRIPTION

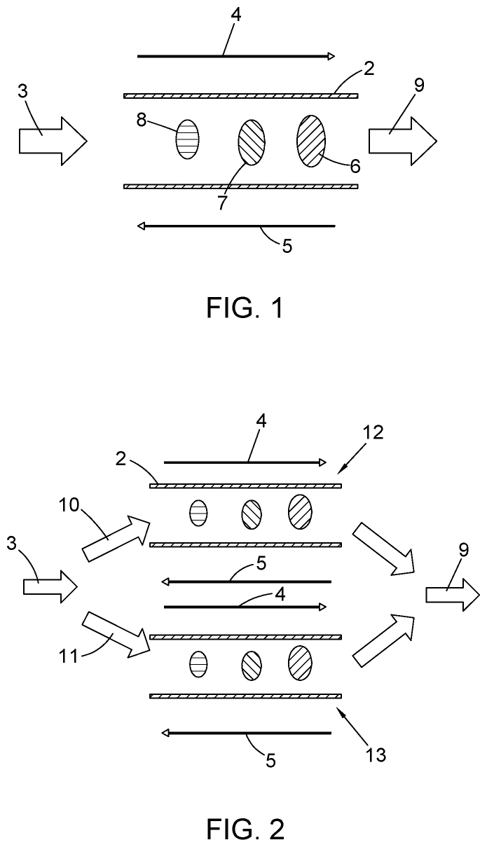

FIG. 1 shows a schematic of a known IMS device. The IMS device comprises an ion guide 2 that radially confines ions therein. Ions are received at an upstream end, as shown by arrow 3, and are radially confined within the ion guide 2. A gas flow in the downstream direction provides a driving force on the ions in the downstream direction, as illustrated by arrow 4. A DC electric field is applied along the ion guide so as to provide a driving force on the ions in the upstream direction, as illustrated by arrow 5.

The two opposing forces on the ions, caused by the gas flow 4 and the electric field 5, cause the ions to become separated along the ion guide according to their ion mobility. More specifically, the two opposing forces on the ions are balanced at different locations along the ion guide for ions of different mobilities. As such, ions of different mobilities become trapped at different axial positions along a trapping region of the ion guide 2. In FIG. 1. ions 6 represent ions of low mobility, ions 7 represent ions of higher mobility, and ions 8 represent ions of still higher mobility.

When it is desired to release the ions from the ion trapping region, the gradient of the DC electric field 5 is progressively reduced, such that the gas flow 4 is able to force ions to progressively elute from the trapping region in order of ion mobility. The gas flow forces the ions to elute from the downstream end of the trapping region as illustrated by arrow 9 in FIG. 1. Ions 6 of lowest mobility elute first as the electric field gradient is reduced, followed by higher mobility ions 7 as the gradient is reduced further, followed by still higher mobility ions 8 as the gradient is reduced still further.

FIG. 2 shows an embodiment of the present invention. In this embodiment the spectrometer has two IMS devices 12,13, each of which is arranged to receive ions at its upstream end, separate the ions according to mobility and cause ions to be eluted from its downstream end. Each IMS device may be the type described in relation to FIG. 1 or may be a different type of IMS device, as will be described in more detail below. Although only two IMS devices are depicted in FIG. 2, it will be appreciated that one or more further such IMS device may be provided in parallel with the depicted IMS devices.

Ions may be guided towards the multiple IMS devices as a single ion beam 3. The single ion beam may then be split into multiple ion beams 10,11 so that ions simultaneously pass into the upstream ends of the multiple IMS devices whilst they are all simultaneously operating in an ion accumulation mode that traps the ions within a trapping region. Alternatively, the single ion beam 3 may be deflected such that all of the ions in the single ion beam pass into only a single one of the IMS devices at any given time, whilst that IMS device is operating in an ion accumulation mode so as to trap the ions within a trapping region. In this embodiment the ions from the single ion beam 3 are directed into different IMS devices at different times.

As multiple IMS devices are provided in parallel, embodiments of the present invention provide a relatively high space-charge capacity since, at any given time, ions may be distributed throughout multiple trapping regions of the multiple IMS devices.

During or after the accumulation of ions in the trapping region of any given IMS device, that IMS device separates the ions according to their mobility. The separated ions are then caused to elute from a downstream exit of the IMS device, e.g. such that ions of progressively higher mobility exit the IMS device as time progresses or such that ions of progressively lower mobility exit the IMS device as time progresses.

Ions may elute from the exits of the multiple IMS devices simultaneously and these multiple ion streams from the multiple IMS devices may be combined to form a single ion beam 9, as shown in FIG. 2. In such embodiments, the multiple IMS devices are preferably synchronised such that at any given time the ions exiting all of the IMS devices have the same mobility. This enables the ions to remain separated according to mobility in the combined ion beam 9. This may be preferred in the embodiments in which the single ion beam 3 received by the IMS devices is split such that ions enter the multiple IMS devices at the same time.

In the embodiments in which the single beam of ions 3 is directed into different IMS devices at different times, the multiple IMS devices may still be synchronised such that at any given time the ions exiting all of the IMS devices have the same mobility, so that the ions in the combined ion beam may be separated according to mobility.

Alternatively, at any given time, the ions eluting from different IMS devices may have different mobilities. For example, the IMS device that was first filled by the single ion beam at a first fill time may begin to elute ions of a first mobility at a first elution time, whereas the IMS device that was filled by the single ion beam at a second fill time that is later than the first fill time may begin to elute ions of the first mobility at a second elution time that is later than the first elution time. The spectrometer may still be configured to combine the ions from the multiple IMS devices into a single ion beam such that the ions remain separated according to mobility in the single ion beam.

The ions eluting from the multiple IMS devices may be combined into a single ion beam in a substantially continuous manner. Alternatively, the ions eluting from the multiple IMS devices may be combined into a single ion beam discontinuously, e.g. ions having a range of mobilities may elute from the first IMS device, and only ions of having a smaller range of mobilities from the second IMS device may be combined with them.

Each of the IMS devices may be an IMS device of the type described in relation to FIG. 1. As such, the IMS device may comprise an ion guide 2, such as an elongated ion guide, having electrodes and RF voltages applied thereto such that ions are radially confined within the ion guide. The ion guide 2 may be an ion tunnel ion guide, e.g. formed from apertured electrodes such as ring electrodes, or any other type of ion guide, such as a multipole rod set ion guide. Ions are received at an upstream end of the ion guide and enter the ion guide, at least during an ion accumulation period. The ions are radially confined within the ion guide and are prevented from exiting the downstream end of the ion guide during the ion accumulation period. As such, the ions are trapped within a trapping region of the ion guide, which may be an axially elongated volume.

The ions are separated out in the axial direction along the ion trapping region by applying forces on the ions in opposing axial directions, as will be described further below. Ions may be prevented from entering or exiting the trapping region whilst the ions are separated according to mobility. After the ions have been separated by mobility, the IMS device may be caused to elute the ions in increasing order, or decreasing order, of mobility.

Each IMS device 12,13 may separate ions according to mobility by providing a gas flow 4 that urges the ions in a first axial direction and applying voltages to the electrodes of the ion guide so as to urge the ions in a second, opposite axial direction. The gas flow may be provided in the downstream direction (i.e. towards the ion exit of the IMS device), which is typically more simple to achieve since the pressure in a spectrometer tends to decrease in the downstream direction. However, it is contemplated that the gas flow may alternatively be in the second axial direction (i.e. the upstream direction) and the voltages may urge the ions in the opposite direction.

As described above, voltages may be applied to the ion guide 2 so as to urge the ions in the second axial direction against the gas flow. The voltages are selected such that the gas flow 4 is able to push ions of different mobility (i.e. mobility through the gas) to different axial positions along the ion guide. More specifically, the gas flow will push ions of relatively low mobility against the opposing force that is due to the voltages until these ions reach a position relatively far along the ion guide in the first direction, whereas the gas flow will only be able to push ions of higher mobility a shorter distance along the ion guide in the first direction. The voltages may be arranged to provide a static DC electric field 5 that urges ions in the second direction. The electric field may have a gradient such that the magnitude of the electric field increases as a function of increasing distance in the first direction, e.g. the amplitude of the DC potential may increase quadratically as a function of increasing distance in the first direction. Alternatively, a DC potential may be repeatedly travelled along the ion guide in the second axial direction so as to urge ions against the gas flow. The DC potential may reduce in amplitude as it travels in the second axial direction.

After the ions have been separated according to mobility, within the trapping region, the ions may be caused to elute from the exit of the IMS device 12, 13 by progressively varying the voltages such that the gas flow 4 pushes ions of progressively higher mobility to elute from the IMS device in the first direction as time progresses. For example, the gradient of the electric field 5 may be reduced with time so as to achieve this, either by stepping the gradient down with time or by scanning it down with time in a substantially continuous manner. Alternatively, if the gas flow 4 is in the upstream direction and the electric field 5 urges ions in the downstream direction then the ions may be caused to elute from the exit of the IMS device by progressively varying the voltages such that the force from the DC voltages 5 pushes ions of progressively lower mobility to elute from the IMS device in the first direction as time progresses. For example, the gradient of the electric field may be increased with time so as to achieve this, either by stepping the gradient up with time or by scanning it up with time in a substantially continuous manner.

A constant electric field region may be provided immediately downstream of the trapping region, which further separates the ions according to mobility once they elute from the trapping region. The magnitude of the electric field in the constant electric field region is substantially constant, along the constant electric field region, at any given time. The magnitude of this electric field is substantially the same as the magnitude of the electric field at the downstream end of the trapping region. As such, when the electric field in the trapping region is varied with time so as to cause ions of different mobility to elute, the electric field in the constant electric field region will vary with time in a corresponding manner.

As described below, rather than using a static axial electric field to urge ions against the gas flow, one or more DC potential may be repeatedly travelled along the ion guide in the direction opposite to the direction of the gas flow. Each time the one or more DC potential is travelled along the ion guide, it may decrease in amplitude (and/or increase in speed) as it travels.

When the ions have been separated according to mobility within the trapping region, the ions may be caused to elute from the exit of the IMS device by progressively varying at least one property of the one or more DC potential that is being repeatedly travelled along the ion guide, such that the gas flow pushes ions of progressively higher mobility to elute from the IMS device in the first direction as time progresses. For example, when the gas flow is in the first direction and the DC potentials are travelled in the second direction, the amplitude of the one or more DC potential may be progressively reduced (being smaller at any given point along the ion guide in the elution mode, as compared to when being operated in the trapping mode prior to ions eluting). Alternatively, or additionally, the speed of the one or more DC potential in the second direction may be progressively increased (being higher at any given point along the ion guide in the elution mode, as compared to when being operated in the trapping mode prior to ions eluting).

Alternatively, when the gas flow is in the second (upstream) direction and the DC potential barriers are travelled in the first (downstream) direction, ions may be caused to elute from the exit of the IMS device by progressively varying at least one property of the one or more DC potential barrier that is being repeatedly travelled along the ion guide, such that the one or more DC potential pushes ions of progressively lower mobility to elute from the IMS device in the first direction as time progresses. For example, the amplitude of the one or more DC potential may be progressively increased (being larger at any given point along the ion guide in the elution mode, as compared to when being operated in the trapping mode prior to ions eluting). Alternatively, or additionally, the speed of the one or more DC potential in the first direction may be progressively decreased (being lower at any given point along the ion guide in the elution mode, as compared to when being operated in the trapping mode prior to ions eluting).

Although embodiments have been described in which the axial electric field or DC potentials are varied in order to cause ions to elute, it is contemplated that additionally or alternatively the gas flow rate may be varied so as to cause ions to elute. For example, the gas flow rate may be progressively increased or decreased in any of the embodiments described above so that ions of different mobility elute from the IMS device at different times.

The inventors have recognised that although it is satisfactory to use a gas flow to urge ions against an opposing force in order to separate the ions when using a single IMS device, this presents difficulties when using multiple IMS devices. Providing multiple IMS devices that each use a gas flow to separate the ions results in a relatively high combined gas flow rate through and out of the IMS devices. The IMS devices are located within a vacuum housing of the spectrometer and, as such, the high gas flow rate increases the work that must be done by the vacuum pump(s) of the spectrometer. This can also restrict the gas flow rates that can be used to separate ions and/or the number of such IMS devices that can be used. Accordingly, the maximum space charge capacity is limited when using such gas flow IMS devices.

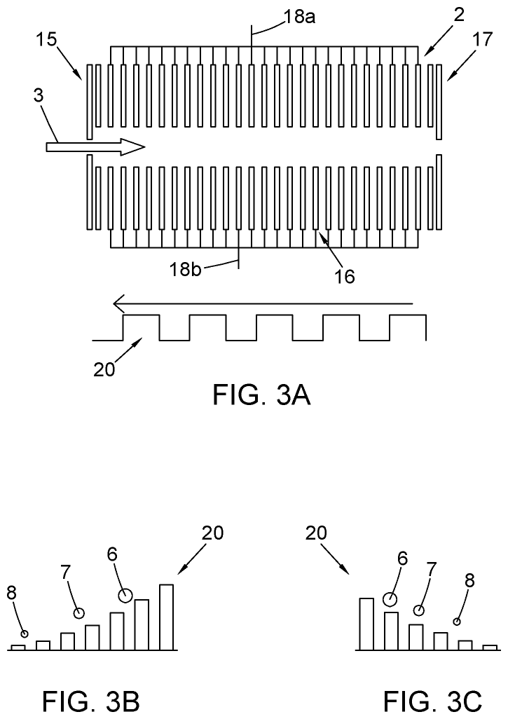

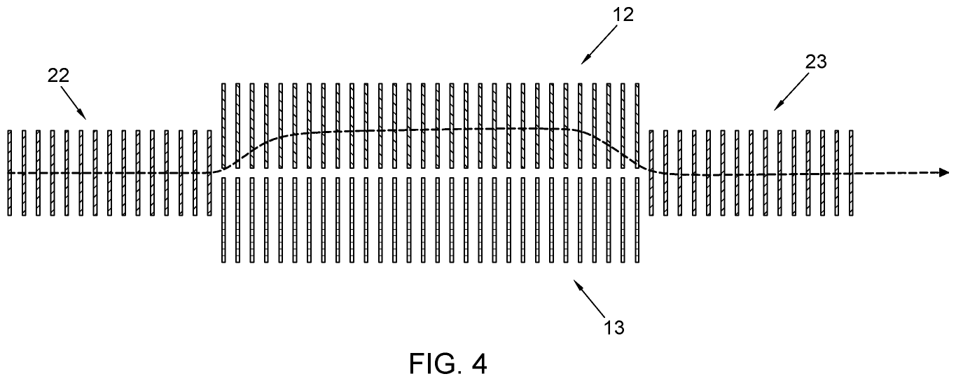

In order to overcome this, embodiments are contemplated wherein at least some of the multiple IMS devices do not rely on gas flow to separate the ions by mobility. For example, one or more of the multiple IMS devices may use voltages to apply forces on the ions in both the first and second directions. FIG. 3A shows a schematic of an IMS device according to such an embodiment.

FIG. 3A shows an IMS device having an ion tunnel ion guide 2 comprising a plurality of electrodes that are spaced along a longitudinal axis of the IMS device, although as described above alternative types of ion guide may be used. The IMS device comprises an entrance electrode 15, a series of intermediate electrodes 16 and an exit electrode 17. Opposite phases 18a, 18b of an RF voltage may be applied to different, e.g. alternate, electrodes 16 in order to produce a pseudo-potential that confines the ions radially within the ion guide.

Voltages may be applied to the ion guide 2 in each of the one or more IMS devices 12, 13 so as to provide a static DC electric field that urges ions in the first (downstream) direction. The axial electric field may be substantially constant, i.e. due to a linear DC potential gradient. One or more DC potential 20 may be repeatedly travelled along the ion guide in the second (upstream) direction so as to urge the ions in the second direction. Each time the one or more DC potential is travelled along the ion guide 2 in the second direction, it may decrease in amplitude (and/or increase in speed) as it travels in the second direction, e.g. as shown in FIG. 3B. The force due to the axial electric field and the force due to the one or more DC potential 20 cause the ions to become separated axially along the trapping region and according to mobility.

When the ions have been separated according to mobility within the trapping region, the ions may be caused to elute from the exit of the IMS device by progressively varying at least one property of the one or more DC potential 20 that is being repeatedly travelled along the ion guide, such that the axial electric field in the first direction pushes ions to elute from the IMS device in the first direction in order of mobility as time progresses (e.g. in order of progressively higher mobility). For example, the amplitude of the one or more DC potential 20 may be progressively reduced (being smaller at any given point along the ion guide in the elution mode, as compared to when being operated in the trapping mode prior to ions eluting). Alternatively, or additionally, the speed of the one or more DC potential in the second direction may be progressively increased (being higher at any given point along the ion guide in the elution mode, as compared to when being operated in the trapping mode prior to ions eluting).

Alternatively, static DC electric field may be arranged to urge ions in the second (upstream) direction and the DC potentials 20 may be repeatedly travelled along the ion guide in the first (downstream) direction so as to urge the ions in the first direction. Each time the one or more DC potential is travelled along the ion guide 2 in the first direction, it may decrease in amplitude (and/or increase in speed) as it travels in the first direction, e.g. as shown in FIG. 3C. The force due to the axial electric field and the force due to the one or more DC potential 20 cause the ions to become separated axially along the trapping region and according to mobility. In these embodiments, ions may be caused to elute from the exit of the IMS device by progressively varying at least one property of the one or more DC potential that is being repeatedly travelled along the ion guide, such that the one or more DC potential pushes ions to elute from the IMS device in the first direction in order of mobility as time progresses (e.g. in order of progressively lower mobility). For example, the amplitude of the one or more DC potential may be progressively increased (being larger at any given point along the ion guide in the elution mode, as compared to when being operated in the trapping mode prior to ions eluting). Alternatively, or additionally, the speed of the one or more DC potential in the first direction may be progressively decreased (being lower at any given point along the ion guide in the elution mode, as compared to when being operated in the trapping mode prior to ions eluting).

Embodiments have been described in which, during the separation mode, the axial electric field is substantially constant and the DC potential varies as it travels along the ion guide. However, it is alternatively contemplated that in the separation mode the magnitude of the axial electric field may vary as a function of distance along the ion guide. For example, when the DC potentials are travelled in the second direction, the magnitude of the axial electric field may decrease with increasing distance in the first direction. Alternatively, when the DC potentials are travelled in the first direction, the magnitude of the axial electric field may increase with increasing distance in the first direction. In the embodiments where the axial electric field varies as a function of distance along the ion guide, the DC potential 20 may not vary in amplitude and/or speed as a function of distance along the ion guide, e.g. as shown in FIG. 3A.

For the avoidance of doubt, the first direction is the direction in which ions are caused to elute from each IMS device, which corresponds to the direction from the ion source to an ion detector in the spectrometer.

As described in relation to FIG. 2, ions are guided from a single ion beam 3 into the upstream ends of the IMS devices 12,13.

FIG. 4 shows a schematic that is substantially the same as the arrangement shown in FIG. 2, except that it illustrates a single upstream ion guide 22 that guides the single ion beam 3 into the upstream ends of the multiple IMS devices 12,13, and also shows a single downstream ion guide 23 that receives the ions eluting from the multiple IMS devices to form the single ion beam 9. The path of the ions that pass through the first IMS device 12 is shown as a dashed line.

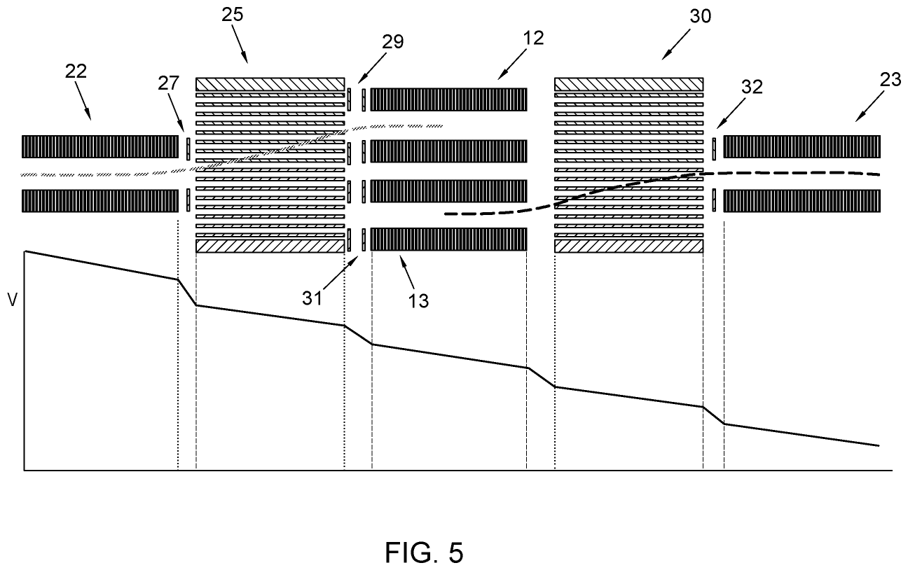

FIG. 5 shows a schematic of an embodiment that is similar to that shown in FIG. 4. This embodiment comprises a single upstream ion guide 22 for guiding ions towards the upstream end of the IMS devices 12, 13 and a single downstream ion guide 23 for receiving ions from the IMS devices. An entrance gate 25 is provided between the upstream ion guide 22 and the IMS devices 12, 13 for use in directing ions into the IMS devices. A deflection electrode 27 may be provided between the upstream ion guide 22 and the entrance gate 25. One or more blocking electrode 29 may be provided between the entrance gate 25 and the IMS devices for preventing ions entering one or more of the IMS devices when that one or more IMS device is operating in an elution mode. An exit gate 30 is provided between the IMS devices 12,13 and the downstream ion guide 23 for use in directing ions into the downstream ion guide. A steering electrode 32 may be provided between the exit gate 30 and the downstream ion guide 23 to assist in steering ions into the downstream ion guide.

FIG. 5 also shows a plot of the DC potential profile that may be provided along the instrument in order to urge ions in the downstream direction.

In operation, ions are urged along the upstream ion guide 22. This ion guide may be an axially segmented ion guide and different voltages may be provided to different axial segments in order to urge ions through it and towards the IMS devices 12,13. At the point in time illustrated by FIG. 5, ions from the upstream ion guide 22 are directed into a first of the IMS devices 12, which is operating in an ion accumulation mode. In this mode, voltages are applied to the entrance gate 25 so that ions are urged only into the first IMS device 12 and not the second IMS device 13. In the depicted embodiment the longitudinal axis through the first IMS device 12 is spaced apart from the longitudinal axis through the upstream ion guide 22, and so the entrance gate 25 urges the ions orthogonally (to the axis through the upstream ion guide) in order to cause the ions to enter the first IMS device. If the one or more deflection electrodes 27 are provided then voltages may be applied to these so as to urge the ions in the orthogonal direction. However, it will be appreciated that in non-illustrated embodiments the longitudinal axis through the first IMS device 12 may instead be aligned with the longitudinal axis through the upstream ion guide 22.

At this moment in time, the blocking electrodes 29 between the entrance gate array 25 and the first IMS device 12 are maintained at a potential such that the ions can enter the trapping region inside the first IMS device. Electric potentials may be applied to the first IMS device, and/or other electrodes, so as to prevent the ions exiting the first IMS device. The first IMS device therefore operates in the ion accumulation mode described above.

Prior to the point in time illustrated in FIG. 5, the instrument had already operated in a corresponding mode to that described above so as to fill the second IMS device 13 during an ion accumulation mode. That is, voltages had been applied to the entrance gate 25 so that ions are urged only into the second IMS device 13 and not the first IMS device 12. As the longitudinal axis through the second IMS device 13 is spaced apart from the longitudinal axis through the upstream ion guide 22, the entrance gate 25 urges the ions orthogonally (to the axis through the upstream ion guide) in order to cause the ions to enter the second IMS device 13. If the one or more deflection electrodes 27 are provided then voltages may be applied to these so as to urge the ions in the orthogonal direction. During this process, the blocking electrodes 31 between the entrance gate array 25 and the second IMS device 13 were maintained at a potential such that the ions can enter the trapping region inside the second IMS device. Electric potentials were applied to the second IMS device 13, and/or other electrodes, so as to prevent the ions exiting the second IMS device. Ions where then separated according to mobility within the trapping region of the second IMS device, in one of the manners described above.

At the point in time illustrated in FIG. 5, the second IMS device 13 has switched to the elution mode in which ions are caused to elute from the second IMS device 13 in order of increasing or decreasing mobility, depending on which of the elution modes described herein is used. Voltages are applied to the exit gate 30 so that eluting ions are urged into the downstream ion guide 23. In the depicted embodiment the longitudinal axis through the downstream ion guide 23 is spaced apart from the longitudinal axes through the first and second IMS devices 12,13, and so the exit gate 30 urges the ions orthogonally (to the axis through the second IMS device) in order to cause the ions to enter the downstream ion guide. If the one or more steering electrodes 32 are provided then voltages may be applied to these so as to urge the ions in the orthogonal direction. However, it will be appreciated that in non-illustrated embodiments the longitudinal axis through the downstream ion guide 23 may instead be aligned with the longitudinal axis through one of the first or second IMS devices 12, 13.

The downstream ion guide 23 may be an axially segmented ion guide and different voltages may be provided to different axial segments in order to urge ions through it and in the downstream direction.

It will therefore be appreciated that ions may be accumulated and/or separated in the first IMS device 12 whilst ions are being separated and/or eluting from the second IMS device 13.

Once the ions in the first IMS device 12 have been separated, then the first IMS device may switch to the elution mode such that ions elute from the downstream end of the first IMS device in increasing or decreasing order of mobility. The voltages applied to the exit gate 30 (and the optional steering electrodes 32) may then be switched so as to guide the ions eluting from the first IMS device 12 into the downstream ion guide 23 in a corresponding manner to that described above in relation to guiding ions from the second IMS device 13 into the downstream ion guide.

When the ions are eluting from the first IMS device 12, the second IMS device 13 may be operating in an ion accumulation mode corresponding to that which has been described above in relation to accumulating ions in the first IMS device. That is, ions from the upstream ion guide 22 are directed into the second IMS device 13 by applying voltages to the entrance gate 25 so that ions are urged only into the second IMS device 13 and not the first IMS device 12. In the depicted embodiment the longitudinal axis through the second IMS device 13 is spaced apart from the longitudinal axis through the upstream ion guide 22, and so the entrance gate array 25 urges the ions orthogonally (to the axis through the upstream ion guide) in order to cause the ions to enter the second IMS device. If the one or more deflection electrodes 27 are provided then voltages may be applied to these so as to urge the ions in the orthogonal direction. At this moment in time, the blocking electrodes 31 between the entrance gate 25 and the second IMS device 13 are maintained at a potential such that the ions can enter the trapping region inside the second IMS device 13. Electric potentials may be applied to the second IMS device 13, and/or other electrodes, so as to prevent the ions exiting the second IMS device. The second IMS device may then operate in one of the ion separation modes described above.

It will therefore be appreciated that ions may be accumulated and/or separated in the second IMS device 13 whilst ions are being separated and/or eluting from the first IMS device 12.

The above processes may be repeated such that the IMS devices 12, 13 are alternately filled with ions, and such that ions elute from alternate ions.

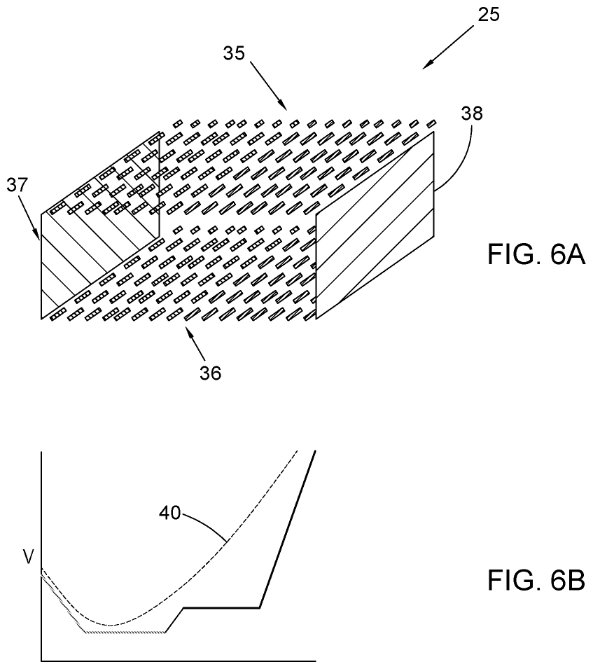

FIG. 6A shows a schematic perspective view of an embodiment of the entrance gate 25. The entrance gate 25 comprises two arrays of electrodes 35,36 that are spaced apart from each other so as to define an ion guiding region therebetween. Each array of electrodes comprises a plurality of electrodes arranged in rows and columns. Various electrical potentials are applied to these electrodes so as to manipulate the ions, as will be described in more detail below. Each of the arrays may be square or rectangular, although other shapes are contemplated. The arrays may be parallel with each other, or may be at an angle to each other, e.g. diverging in the downstream direction for driving ions downstream. The entrance gate 25 may have two side electrodes 37,38 that extend between the arrays 35,36 on two opposing sides of the arrays. The other two sides of the entrance gate 25 that extend between the two arrays form the ion entrance into the entrance gate and the ion exit from the exit gate. Each of these sides may be entirely open or may have a wall with an aperture in it for allowing ions to enter or exit the entrance gate 25.

RF electrical potentials may be applied to the electrodes in the arrays of electrodes 35,36 in order to confine ions in the direction between the arrays. The same phase RF potential may be applied to all of the electrodes in the same column of electrodes (where a column extends in the direction from the ion entrance side to the ion exit side), whereas any given adjacent pairs of columns of electrodes may be maintained at different RF phases, preferably opposite RF phases. However, it is alternatively contemplated that same phase RF potential may be applied to all of the electrodes in the same row (where a row extends in the direction between the side electrodes 37,38), and any given pair of adjacent rows of electrodes may be maintained at different RF phases, preferably opposite RF phases. DC voltages may be applied to the electrodes in the arrays of electrodes 35,36 and/or to the side electrodes 37,38 in order to urge ions in the direction that the rows of electrodes are arranged, as will be described in more detail below.

In operation, ions exit the upstream ion guide 22 along a first axis, enter the entrance gate 25 along this axis, and are confined between the arrays of electrodes 35,36 by the RF voltages applied thereto. Initially, different DC voltages may be applied to different electrodes in each array of electrodes, and optionally different DC voltages may be applied to the opposing side electrodes 37,38, such that the ions are urged orthogonally to the first axis (i.e. orthogonal to the columns) such that the ions exit the entrance gate 25 along a second axis that is displaced from the first axis and enter the first IMS device 12.

FIG. 6B show an example of the DC voltages that may be applied to the side electrodes 37,38 and arrays of electrodes 35,36 in the mode in which ions are being transmitted into the first IMS device 12. A first of the side electrodes 38 is maintained at a higher DC potential than the second of the side electrodes 37, for urging ions in the direction towards the second side electrode 37. The DC potentials that are applied to a first subset of the columns of electrodes, which are proximate to the first side electrode 38, may progressively decrease as a function of distance in a direction away from the first side electrode 38 so as to urge the ions in the direction away from the first side electrode. The DC potentials that are applied to a second subset of the columns of electrodes, which are proximate to the second side electrode 37, may progressively decrease as a function of distance in a direction away from the second side electrode 37 so as to urge the ions in the direction away from the second side electrode and prevent the ions striking the second side electrode. The electrodes in a third subset of the columns of electrodes, which is adjacent to the second subset, may be maintained at the same DC potential. Similarly, the electrodes in a fourth subset of the columns of electrodes, which is adjacent to the first subset, may be maintained at the same DC potential, where that DC potential may be higher than the DC potential applied to the third subset. It will be appreciated that the same DC voltage may be applied to all of the electrodes in any given column of electrodes. The DC potentials described provides a DC potential profile 40 in the region away from the electrodes that serves to guide the ions from the first axis and onto the second axis, where the second axis corresponds to the location of the minimum of the potential profile 40.

In the mode in which the entrance gate 25 guides ions into the second IMS device 13, instead of the first IMS device 12, the potentials applied to the electrodes of the entrance gate may be the mirror image of those shown in FIG. 6B such that the ions are guided from the first axis to a third axis that corresponds to the axis of the second IMS device.

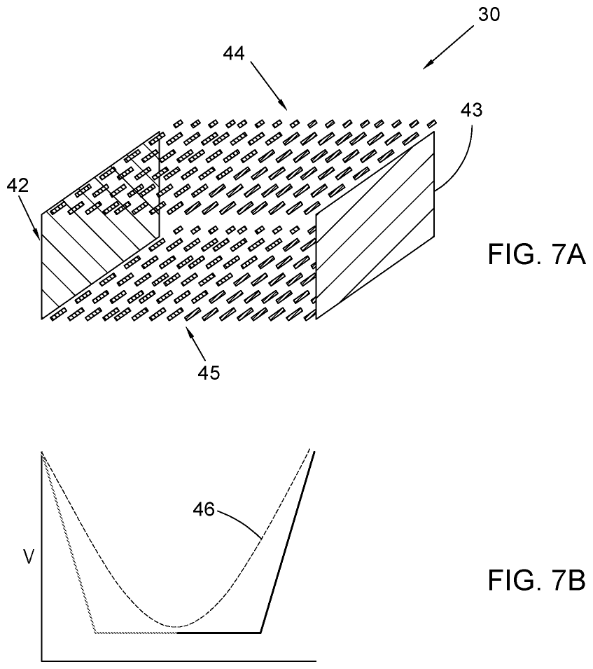

FIG. 7A shows a schematic perspective view of an embodiment of the exit gate 30. The exit gate may be the same as the entrance gate 25, except that different potentials are applied to the electrodes thereof, e.g. as shown in FIG. 7B.

FIG. 7B show an example of the DC voltages that may be applied to the side electrodes 42,43 and arrays of electrodes 44,45 of the exit gate array 30. The first and second side electrodes 42,43 are maintained at first and second DC potentials, which may be the same DC potential. The DC potentials that are applied to a first subset of the columns of electrodes, which are proximate to the first side electrode 42, may progressively decrease as a function of distance in a direction away from the first side electrode so as to urge the ions in the direction away from the first side electrode. The DC potentials that are applied to a second subset of the columns of electrodes, which are proximate to the second side electrode 43, may progressively decrease as a function of distance in a direction away from the second side electrode so as to urge the ions in the direction away from the second side electrode and prevent the ions striking the second side electrode. A third subset of the columns of electrodes that are between the first and second subsets may be maintained at the same DC potential. The DC potentials described provides a DC potential profile 46 in the region away from the electrodes that serves to guide the ions from the exit axis of the first IMS device 12, or the exit axis of the second IMS device 13, onto a third axis which corresponds to the location of the minimum of the potential profile 46. This third axis may correspond to the axis of the downstream ion guide 23.

Although the potential profile in FIG. 7B has been illustrated as being symmetrical about the minimum, this is because the exit gate 30 in the embodiment shown in FIG. 6 is centrally located between the two IMS devices 12, 13 and the downstream ion guide 23 is centrally located relative to the exit gate 30. If this is not the case then the exit gate 30 may apply a non-symmetric potential profile so as to urge ions to the desired axial path.

Although embodiments have been described in which two IMS devices 12, 13 are provided for receiving ions from the upstream ion guide 22, as mentioned above, more than two IMS devices may receive ions from the upstream ion guide. In such embodiments, the entrance gate 25 has an electrode configuration and voltage supplies such that the entrance gate may be applied with voltages so as to selectively guide ions into any one of the multiple IMS devices. Similarly, the exit gate 30 is configured to receive ions from any one of the multiple IMS devices and guide them into the downstream ion guide.

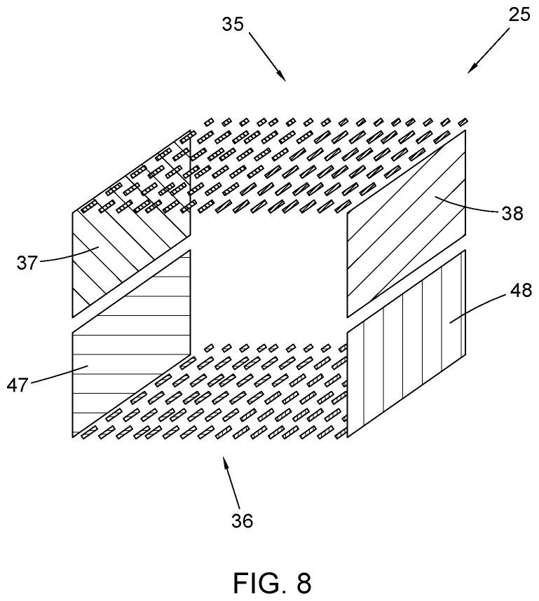

FIG. 8 shows an example of an entrance gate 25 that corresponds to that shown in FIG. 6A, except that instead of having a single side electrode on each of the opposing sides, there is an upper side electrode 37,38 and a lower side electrode 47,48 on each of the sides. This embodiment operates in the same manner as that described in relation to FIGS. 6A-6B in order to guide towards one of the sides. However, this embodiment also selectively guides the ions towards one of the arrays 35,36 of electrodes by applying different DC potentials to the upper side electrodes 37,38 than are applied to the lower side electrodes 47,48, and/or by applying different DC potentials to the upper array 35 than are applied to the lower array 36. The exit gate 30 may be the same as shown in FIG. 7B, except that it may be larger in order to accommodate the extra IMS devices.

It is contemplated that the entrance gate 25 may process the ions in additional ways than just selectively guiding them into a selected IMS device. For example, the entrance gate may perform ion mobility filtering. This is particularly beneficial in reducing the amount of charge entering each IMS device, which has been recognised as a significant issue in IMS devices of the type described herein. For instance, ions of relatively low mobility may be filtered out such that they do not enter the IMS devices.

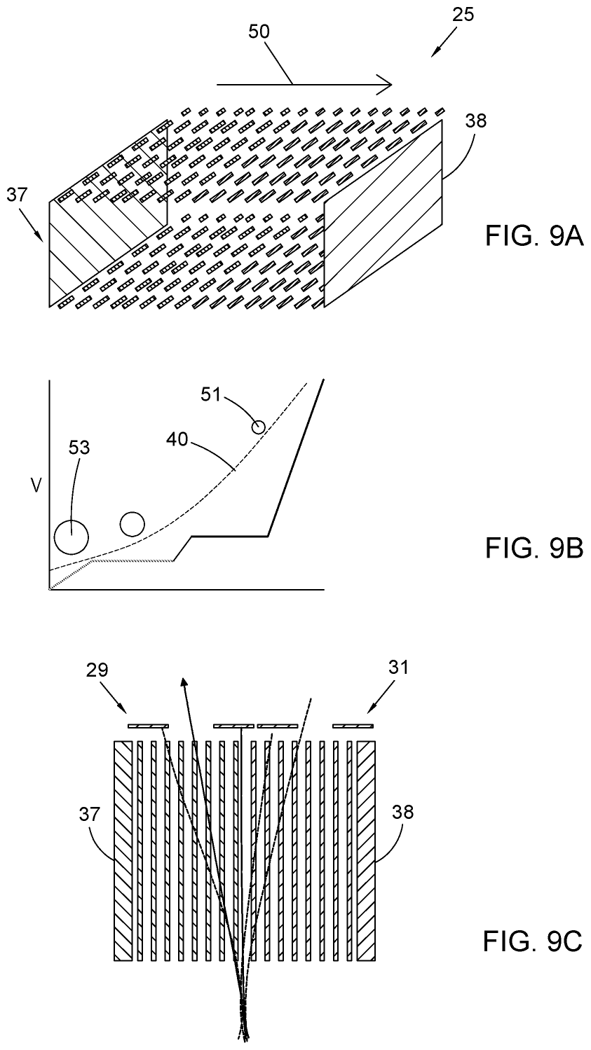

FIGS. 9A-9C show an embodiment of the entrance gate 25 operating as an ion mobility filter. The entrance gate 25 may operate in the same manner as described in relation to FIGS. 6A-6B (or FIG. 8), i.e. where static DC potentials are applied to electrodes of the entrance gate so that it urges the ions orthogonally from the first axis towards one of the sides 37,38. However, in addition to this, a DC potential is repeatedly travelled in the opposite direction 50 so as to urge the ions towards the opposite side. This may be performed by sequentially applying a DC potential to sequential columns of electrodes so that the DC potential is travelled towards said opposite side 50.

FIG. 9B shows an example of the static DC potentials that may be applied to the entrance gate 25 in order to urge the ions towards the first side 37. In the depicted embodiment, the potentials are the same as those in FIG. 6B, except that the potential applied to the second side electrode 37 may be removed and/or the potentials applied to second subset of electrodes decrease as a function of increasing distance away from the third subset of electrodes. This is possible because the travelling DC potentials prevent the ions of interest from striking the second side electrode 37. The static DC potential gradient may provide an electric field having a magnitude that increases as a function of distance towards the first side electrode 38, e.g. the DC potential amplitude may increase substantially quadratically as a function of distance towards the first side electrode 38.

The gas pressure within the entrance gate is such that the opposing forces on the ions due to the DC travelling potentials 50 and the DC static gradient cause the ions to separate out according to their mobility until they reach their equilibrium position at which the time-averaged force on any given ion due to the DC travelling potentials 50 is equal to and opposite to the force on the ion due to the DC static gradient. As can be seen from FIG. 9B, ions of relatively high mobility 51 are urged orthogonally to an equilibrium position that is relatively close to the first side electrode 38, whereas ions of relatively low mobility 53 are urged orthogonally to an equilibrium position that is relatively close to the second side electrode 37.

FIG. 9C shows a plan view of the ion entrance gate 25 and illustrates the different ion trajectories of ions of different mobilities. As described above, ions of relatively low mobility are urged relatively far towards the first side electrode 38, whereas ions of relatively high mobility are urged relatively far towards the second side electrode 37. The ions therefore exit the entrance gate 25 at different positions depending on their mobilities. The static DC gradient and/or parameters of the DC travelling potentials 50 (e.g. amplitude and/or speed etc.) may be selected such that ions of the desired mobility exit the entrance gate 25 at a location so as to be able to enter the desired IMS device. An ion blocking plate 29,31 may be provided between the entrance gate 25 and the IMS devices 12,13, where the ion blocking plate has an orifice positioned at the entrance to each IMS device. Ions of the desired mobility are then directed through one of the orifices into the desired IMS device, whereas ions of other mobilities will strike the ion blocking plate.

Although embodiments have been described in which the static DC gradient urges ions towards the second side electrode 37 and the DC travelling potentials 50 urge the ions towards the first side electrode 38, it is contemplated that alternatively the static DC gradient may urge ions towards the first side electrode 38 and the DC travelling potentials 50 may urge the ions towards the second side electrode 37.

Different DC potentials may be applied to different rows of electrodes so as to urge ions downstream from the entrance of the entrance gate 25 to its exit. In embodiments where it is not desired to perform this function, each column of electrodes may be replaced by an elongated continuous electrode, e.g. as shown in FIG. 9C.

The entrance gate 25 has been described in a mode where it operates as an ion mobility filter whilst filling the first IMS device 12. However, the entrance gate 25 may be operated in a corresponding manner in order to mobility filter ions when it is filling another of the IMS devices 13. The entrance gate 25 may operate as an ion mobility filter such that the same range of mobilities enters each IMS device, or such that different ranges of mobilities enter different IMS devices.

Although embodiments have been described in which the entrance gate 25 directs ions into a single IMS device 12,13 at any one time, it will be appreciated that voltages may be applied to the electrodes of the entrance gate 25 such that it receives a single ion beam 3 from the upstream ion guide 22 and splits that ion beam such that ions are simultaneously directed into multiple IMS devices 12,13. For example, the voltages may be applied such that the potential profile 40 does not have a single potential minimum as shown in FIG. 6B, but rather that the potential profile has multiple minima at locations for guiding the ions into the multiple IMS devices.

The ion entrance gate may be of a form other than that shown and described above.

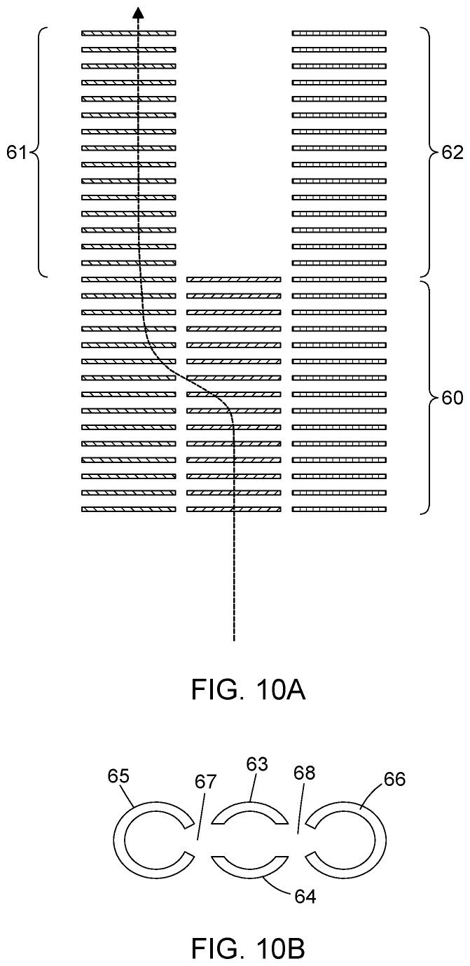

FIGS. 10A-10B shows another embodiment of the ion entrance gate. The ion entrance gate comprises a first, transition portion 60 located to receive ions from the upstream ion guide 22 along a first axial path, a second portion 61 configured to guide ions along a second different axial path to the first IMS device 12, and a third portion 62 configured to guide ions along a third and different axial path to the second IMS device 13. The entrance gate may be configured such that the first axial path is substantially parallel to and displaced from the second and third axial paths.

Each of the transition portion 60, first portion 61, and second portion 62 may comprise a plurality of axially spaced electrodes, where each electrode is an electrode having an aperture through which ions are transmitted in use.

FIG. 10B shows a cross-sectional view, in the downstream direction, of the ion entrance gate at a location near the upstream end. As can be seen, the transition portion 60 comprises upper and lower electrodes 63,64 arranged on opposite sides of the first axial path. The upper and lower electrodes are spaced apart by gaps on opposing sides of the first axial path such that ions can be urged orthogonally from the first axial path to either the second or third axial paths, as will be described further below. The transition portion 60 also comprises a C-shaped electrode 65 which only partially surrounds the second axial path and which has a gap in its circumference that faces one of the gaps between the upper and lower electrodes 63,64. The transition portion 60 comprises a further C-shaped electrode 66, which only partially surrounds the third axial path and which has a gap in its circumference that faces the other gap between the upper and lower electrodes 63,64 of the transition portion. The electrode arrangement illustrated in FIG. 10B shows the electrodes at one axial location along the transition portion 60, but a stack of such electrode arrangements may be repeated along the axis of at least a portion of the transition portion 60.

The second portion 61 may comprise an ion tunnel ion guide, such as a stacking ring ion guide, that is arranged to receive ions from the transition portion 60 along the second axial path. Similarly, the third portion 62 may comprise an ion tunnel ion guide, such as a stacking ring ion guide, that is arranged to receive ions from the transition portion 60 along the third axial path.

RF voltages are applied to the upper electrodes 63, lower electrodes 64 and C-shaped electrodes 65,66 of the transition portion 60 and also to the electrodes of the first and second portions 61,62 for radially confining ions within them. In each of these portions, the electrodes that are arranged adjacent to each other, in the axial direction, may be at different RF phases, such as opposite RF phases. In contrast, the electrodes of the transition portion 60 that are adjacent to each other in the lateral direction (e.g. all of the electrodes in FIG. 10B) may be at the same RF phase. Different DC voltages may be applied to different electrodes in the axial direction in order to urge ions downstream through the transition portion and/or through the first and second portions.

In use, ions enter the transition portion 60 between the upper and lower electrodes 63,64 and travel along the first axial path. When it is desired to transmit ions into the first IMS device 12, a DC potential difference is applied between the upper/lower electrodes 63,64 and at least some of the C-shaped electrodes 65 that surround the second axial path so as to urge the ions radially from the first axial path, through the gap 67, and onto the second axial path. The RF voltages applied to these C-shaped electrodes 65 guide the ions along the second axial path into the second portion 61 of entrance gate 25, which then guides the ions into the first IMS device 12. Similarly, when it is desired to transmit ions into the second IMS device 13, a DC potential difference is applied between the upper/lower electrodes 63,64 and at least some of the C-shaped electrodes 66 that surround the third axial path so as to urge the ions radially from the first axial path, through the gap 68, onto the third axial path. The RF voltages applied to these C-shaped electrodes 66 guide the ions along the third axial path into the third portion 62 of entrance gate, which then guides the ions into the second IMS device 13.

Furthermore, the transition portion 60 may be configured to transmit ions to a third, or further, IMS device. For example, in such an arrangement, a second series of upper and lower electrodes corresponding to those described above, but that surround a fourth axial path, may be provided between the upper/lower electrodes 63,64 that surround the first axial path and the C-shaped electrodes 65 that surround the second axial path. The entrance gate may have a fourth portion, such as an ion tunnel ion guide that receives ions from the second series of electrodes and guides them to the third IMS device. In use, different DC potentials may be applied to different electrodes of the transition region 60 such that ions are urged from the first axial path to the fourth axial path and therefore to the third IMS device. Alternatively, different DC potentials may be applied to different electrodes of the transition region 60 such that ions are urged from the first axial path, through the fourth axial path and to the second axial path, and therefore transmitted to the first IMS device 12.

Although the transition portion 60, first portion 61 and second portion 62 of the entrance gate 25 have been described as being axially segmented ion guides, it is alternatively contemplated that one, two or all of these portions may be formed from multipoles having continuously extending electrodes. The electrodes of such multipole have circumferential gaps such that ions can be urged from the first axial path onto the second and third axial paths.

The exit gate 30 may have a corresponding configuration to that described above in relation to FIGS. 10A-10B, but operated in reverse. For example, the second portion 61 may receive ions from the first IMS device 12 and guide those ions to the transition portion 60. Different DC potentials may be applied to different electrodes of the transition portion so as to urge ions from the second axis of the second portion onto the first axis. Ions may then be guided along the first axis into the downstream ion guide 23. Similarly, the third portion 62 may receive ions from a second IMS device 13 and guide those ions to the transition portion. Different DC potentials may be applied to different electrodes of the transition portion so as to urge ions from the third axis of the third portion onto the first axis. Ions may then be guided along the first axis into the downstream ion guide 23.

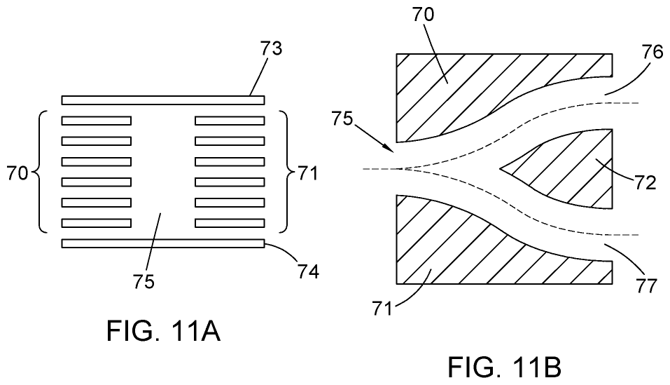

FIGS. 11A-11B show another embodiment of the ion entrance gate. FIG. 11A show an end on view of the entrance gate when looking towards the ion entrance, whereas FIG. 11B shows a plan view of the entrance gate (with the top plate removed for ease of view).

As best seen in FIG. 11A, the entrance gate comprises stacks of plate electrodes 70,71,72 arranged between a top plate electrode 73 and a bottom plate electrode 74. The stacks of electrodes are arranged so as to define an ion guiding path for guiding ions from a first entrance port 75 towards second and third exit ports 76,77. FIG. 11B shows a plan view where the top plate 73 is not illustrated, and therefore shows one layer of the electrodes in the stacks of electrodes 70-72. It will be appreciated that multiple such layers of electrodes are stacked between the top and bottom plate electrodes 73,74. The electrodes in the stacks, and optionally the top and bottom electrodes, may be maintained at RF voltages such that ions are repelled from them. Adjacent electrodes, in the direction between the top and bottom electrodes, may be maintained at different phases of the RF voltage, such as opposite phases. Electrodes in different stacks, but within the same layer (i.e. horizontally adjacent electrodes), may be maintained at the same RF phase. A DC voltage may be applied to the top and bottom electrodes in addition to, or alternatively to, applying the RF voltages in order to repel ions.

In use, ions are received at the first port 75 and are guided through an entrance region of the entrance gate. Different DC voltages may be applied to electrodes in the different stacks of electrodes 70-72 so as to control the path that the ions take through the entrance gate. For example, different DC voltages may be applied to the different stacks 70-72 such that ions are guided only along a first path to a second port 76 and into the first IMS device 12. Similarly, when desired, different DC voltages may be applied to the different stacks such that ions are guided only along a second path to a third port 77 and into the second IMS device 13. Alternatively, different DC voltages may be applied to the different stacks such that ions are simultaneously guided along both the first and second paths to the second and third ports 76,77, and into both the first and second IMS devices 12,13.

The top and bottom plate electrodes 73,74, and/or the stacks of electrodes 70-72, may be segmented in the direction between the entrance 75 and exits 76,77, and different DC voltages may be applied to different segments so as to urge the ions in the downstream direction.

The exit gate 30 may have a corresponding configuration to that described above in relation to FIGS. 11A-11B, but operated in reverse. For example, the second port 76 may receive ions from a first IMS device 12 and guide those ions to the first port 75. Similarly, the third port 77 may receive ions from a second IMS device 13 and guide those ions to the first port 75. Alternatively, ions may be simultaneously guided from both the second and third ports 76,77 to the first port 75. Ions exiting the exit gate 30 through the first port 75 may then pass into the downstream ion guide 23.

Although the present invention has been described with reference to various embodiments, it will be understood by those skilled in the art that various changes in form and detail may be made without departing from the scope of the invention as set forth in the accompanying claims.

For instance, although the ions eluting from the multiple IMS devices have been described as being combined into a single ion beam, it is alternatively contemplated that the ions eluting from the multiple IMS devices may be processed (e.g. mass analysed and/or detected) independently of each other.

The IMS devices may be controlled so as to trap and separate the same range of mobilities. Alternatively, different IMS devices may be controlled so as to trap, separate and elute different respective ranges of mobilities.

The ions in the single beam may be simultaneously split between the IMS devices, or sequentially directed into the different IMS devices at different times, such that the different IMS devices trap ions having substantially the same charge (at the end of the ion accumulation mode). For example, if the single ion beam is simultaneously split between the IMS devices then the ions may be split such that each IMS device receives the same proportion of the single ion beam for the same time. If the single ion beam is sequentially directed into the different IMS devices at different times, the single ion beam may be directed to each IMS device for the same duration.

Alternatively, the ions in the single beam may be simultaneously split between the IMS devices, or sequentially directed into the different IMS devices at different times, such that the different IMS devices trap ions having different charge (at the end of the ion accumulation mode). For example, if the single ion beam is simultaneously split between the IMS devices then the ions may be split such that the different IMS devices receive different proportions of the single ion beam (e.g. over the same duration). If the single ion beam is sequentially directed into the different IMS devices at different times, the single ion beam may be directed to each IMS device for different durations.

Although embodiments have been described in which the ions elute from the multiple IMS devices simultaneously, the arrangement of multiple IMS devices may be used to improve the duty cycle of the instrument by accumulating ions in one IMS device while an ion population is being eluted from another of the IMS devices.

Embodiments have been described in which ions enter each IMS device directly into a (first) trapping region in which ions are separated according to mobility and then eluted from. However, it is contemplated that at least one, or at least some, of the IMS devices may have a second trapping region upstream of this first trapping region. Ions may be accumulated in the second trapping region (with or without being separated according to mobility), whilst ions are trapped in and eluting from the first trapping region. Once all of the ions have been eluted from the first trapping region then the ions may be transferred from the second trapping region into the first trapping region, and then these ions are separated by mobility and cause to elute from the first trapping region according to mobility. This process may be repeated, thus increasing the duty cycle of the instrument still further, since ions can be trapped in the second trapping region, rather than being discarded, whilst ions are being separated and eluting from the first trapping region.

The ion guide of each IMS device may have a circular, annular, oval, rectangular or other elongated shape cross-section. The IMS devices may have the same or different cross-sectional shapes.

The embodiments described may form part of a mass spectrometer. For example, ions eluting from the IMS devices, or ions derived therefrom, may be mass analysed (e.g. in a Time of Flight mass analyser).

Although the ions have been described as being separated by mobility, it is contemplated that the ions could alternatively be separated by another physicochemical property, such as mass to charge ratio. This may be performed, e.g. in the embodiments where the ions are subjected to opposing forces due to a static axial electric field and travelling DC potentials.

1. An ion mobility separation apparatus comprising:
a plurality of ion mobility separator (IMS) devices arranged in parallel;
an entrance gate configured to direct ions into one or more of said IMS devices at any given time; and
control circuitry configured to operate each of the IMS devices in a separation mode in which first voltages are applied to electrodes of the IMS device so as to provide a static DC electric field that urges ions along the IMS device in one direction, and to also apply second voltages to electrodes of the IMS device so as to provide a DC potential that repeatedly travels along the IMS device in the opposite direction such that ions separate according to their mobility within the IMS device.

2. The apparatus of claim 1, configured to operate each of the IMS devices in an elution mode, after operating in the separation mode, during which:
(i) the first voltages are progressively varied so that a gradient of the static DC electric field progressively varies in a manner that causes ions to elute from the IMS device in order of mobility, or reverse order of mobility, as time progresses; and/or
(ii) the second voltages are progressively varied such that at least one property of the DC potential that is repeatedly travelled along the IMS device is progressively varied so as to cause ions to elute from the IMS device in order of mobility, or reverse order of mobility, as time progresses.

3. The apparatus of claim 2, comprising control circuitry configured to control the elution of ions from the plurality of IMS devices such that at any given time the ions exiting all of the IMS devices have substantially the same mobility.

4. The apparatus of claim 2, comprising control circuitry configured to control the ion mobility separation apparatus such that, during a first time period, the entrance gate causes ions to be supplied into a first of the IMS devices so as to accumulate and separate ions in the first IMS device and such that, whilst the ions are being accumulated and separated, a second of the IMS devices is caused to elute ions in order of ion mobility or in reverse order of ion mobility; and optionally
wherein the control circuitry is configured to control the ion mobility separation apparatus such that, during a second subsequent time period, the entrance gate causes ions to be supplied into the second of the IMS devices so as to accumulate and separate ions in the second IMS device and such that, whilst the ions are being accumulated and separated in the second IMS device, the first IMS device is caused to elute ions in order of mobility or in reverse order of ion mobility.

5. The apparatus of claim 1, further comprising an upstream ion guide for guiding an ion beam to the entrance gate, wherein the entrance gate is configured to either:
(i) split the ion beam into a plurality of ion beams that are simultaneously directed into a respective plurality of the IMS devices; or
(ii) direct the ion beam into different ones of the IMS devices at different times.

6. The apparatus of claim 1, wherein the entrance gate is arranged to receive ions along a first axis and comprises opposing arrays of electrodes that are spaced apart from each other and at least one voltage source for applying at least one RF voltage to the electrodes of said arrays for confining ions in an ion guiding region between the arrays.

7. The apparatus of claim 6, wherein the entrance gate comprises a side electrode on each side of the first axis and at least one voltage supply for applying voltages to the side electrodes so as to urge the ions orthogonal to the first axis.

8. The apparatus of claim 6, wherein each of the IMS devices has a longitudinal axis therethrough along which ions are received; wherein at least one, or each of at least some, of the IMS devices has its longitudinal axis displaced from the first axis; and wherein the entrance gate has control circuitry configured to apply different DC voltages to different electrodes in the arrays, and/or to different side electrodes, so as to deflect ions received along said first axis onto one or more longitudinal axis of one or more of the IMS devices so that the ions enter said one or more of the IMS devices.

9. The apparatus of claim 8, wherein the different DC voltages provide a static DC electric field that urges the ions in a first direction that is orthogonal to the first axis, and the control circuitry is configured to also apply voltages to electrodes of the entrance gate so as to provide a DC potential that repeatedly travels in a second direction along the entrance gate that is opposite to the first direction such that ions separate according to their mobility along the first direction and hence have different trajectories through the entrance gate.

10. The apparatus of claim 6, wherein different DC potentials are applied to different electrodes in the arrays so as to urge ions along the first axis from an entrance of the entrance gate to its exit.

11. The apparatus of claim 1, wherein the entrance gate comprises a first, transition portion having electrodes located to receive ions along a first axial path, a second portion having electrodes configured to guide ions along an axial path to a first of the IMS devices, and a third portion having electrodes configured to guide ions along an axial path to a second of the IMS devices, wherein the electrodes that receive ions along the first axial path are arranged to provide at least one gap at a circumferential location around the first axial path, and wherein the entrance gate comprises a voltage supply for applying DC voltages to the electrodes of the entrance gate so that ions are urged orthogonally from the first axial path, through the at least one gap, and onto the axial path to the first and/or second IMS device.

12. The apparatus of claim 1, wherein the entrance gate comprises at least one stack of plate electrodes arranged between a first electrode and a second electrode so as to define a first ion guiding path for guiding ions from an ion entrance region of the entrance gate to a first of the IMS devices, and a second ion guiding path for guiding ions from the ion entrance region to a second of the IMS devices.

13. The apparatus of claim 1, further comprising a downstream ion guide and an exit gate between the IMS devices and the downstream ion guide, wherein the exit gate is configured to receive ions from the plurality of IMS devices and guide the ions into the downstream ion guide.

14. An ion mobility separation apparatus comprising:
a plurality of ion mobility separator (IMS) devices arranged in parallel;
an entrance gate configured to direct ions into one or more of said IMS devices at any given time; and
control circuitry configured to operate each of the IMS devices in a separation mode in which voltages are applied to electrodes of the IMS device so as to urge ions along the IMS device in one direction, and wherein the apparatus is configured to provide a gas flow in the opposite direction such that ions separate according to their mobility within the IMS device.

15. An ion separation apparatus comprising:
a plurality of separator devices arranged in parallel, each for separating ions according to a physicochemical property;
an entrance gate configured to direct ions into one or more of said separator devices at any given time; and
control circuitry configured to operate each of the separator devices in a separation mode in which first voltages are applied to electrodes of the separator device so as to provide a static DC electric field that urges ions along the separator device in one direction, and to also apply second voltages to electrodes of the separator device so as to provide a DC potential that repeatedly travels along the separator device in the opposite direction such that ions separate according to a physicochemical property within the separator device.

16. The ion separation apparatus of claim 15, wherein the physicochemical property is mass to charge ratio.

17. A method of separating ions by ion mobility comprising:
providing an ion mobility separation apparatus according to claim 1;
providing ions to the entrance gate and controlling the entrance gate so as to direct ions into one or more of said IMS devices at any given time; and
operating the IMS devices so as to operate, simultaneously or sequentially, in the separation mode so as to separate ions according to their mobility.

18. A method of separating ions according to a physicochemical property, comprising:
providing an ion separation apparatus according to claim 15;
providing ions to the entrance gate and controlling the entrance gate so as to direct ions into one or more of said separation devices at any given time; and
operating the separation devices so as to operate, simultaneously or sequentially, in the separation mode so as to separate ions according to the physicochemical property.
